(19) United States
(12) Patent Application Publication
(10) Pub. No.: US 2006/0088651 A1
(43) Pub. Date: Apr. 27, 2006

(54) Protein fortifying composition for fortifying meats and process for preparing same

(76) Inventors: Arno E. Sandoval, Wildwood, MO (US); Matthew K. McMindes, Chesterfield, MO (US); Dale A. Engelbrecht, St. Louis, MO (US); Eduardo Godinez, Chesterfield, MO (US)

Correspondence Address: SOLAE, LLC, P. O. BOX 88940, ST. LOUIS, MO, 63188, US

(21) Appl. No.: 10/971,822

(22) Filed: Oct. 22, 2004

(51) Int. Cl. A23J 1/00

(52) U.S. Cl. 426/656

(57) ABSTRACT

Disclosed is a protein fortified meat, comprising intact skeletal meat muscle tissue as the sole meat source, having incorporated into the muscle tissue of said meat a protein fortifying composition, comprising; (A) a vegetable protein material, (B) a dairy whey protein material and (C) a curing material. Also disclosed is a process for preparing a protein fortified meat, comprising intact skeletal meat muscle tissue as the sole meat source, having incorporated into the muscle tissue of said meat a brine of a protein fortifying composition, comprising; combining (A) a vegetable protein material and (B) a diary whey protein material with (C) an aqueous solution of a curing material to form the brine of the protein fortifying composition; and injecting the brine of the protein fortifying composition into the meat.

### FIELD OF THE INVENTION

The present invention relates to the protein fortification of meats, especially cured meats. It is known to add certain inorganic phosphorus containing compounds, especially polyphosphates, to meat and meat products in order to improve their structure and juice retention, especially when heated. Further, this invention relates to a meat pumping process employing soy protein isolate and, more particularly, a soy protein isolate which is rapidly dispersible in water to provide a portion of the pumping medium, i.e., “brine”.

### BACKGROUND OF THE INVENTION

The pumping of hams with brine, sometimes referred to as “pickle”, probably antedates recorded history. The most common salt employed is sodium chloride which provides curing (color), preservative (shelf life) and organoleptic (taste) functions. Also, for a long time, the salt has been augmented by sugar which also provides the same type of functions. Because the addition of the brine permitted the possible addition of excess water, most authorities have provided stringent regulations on the weight increase in hams due to salt solution addition. However, there was and is a natural limitation as to the amount of water which can be introduced into a ham for the purpose of preservation and taste, i.e., moistening, because of loss on cooking. This, irrespective of the type of curing salts, common supplements to the sodium chloride being sodium nitrite and sodium erythorbate, both of which enhance color.

Extensive investigation was made of various phosphates which were believed to have the ability to bind additional water in meat fibers—and increasingly following World War II, various polyphosphates were added to the brine solution. None of the salts in the brine provided any nutritional value, particularly of a protein nature.

Starting in the mid 1960's, soy protein isolate was viewed as an especially attractive supplement to the brine to permit the introduction of more fluid while maintaining the nutrition level, particularly relative to protein. Soy protein isolate (sometimes referred to as “isolated soy protein”), is defined as the major proteinaceous fraction of soybeans prepared from high quality, sound, clean dehulled soybeans by removing a preponderance of the non-protein components and containing not less than 90% protein (N times 6.25) on a moisture free basis. This definition was accepted by the United States Food and Drug Administration as well as the Technical Service Division, Consumer and Marketing Service, United States Department of Agriculture (1961).

Notwithstanding the opportunity of introducing more effective brine through the use of soy protein isolate, the technique was not formally recognized by the United States Department of Agriculture until May 28, 1976. This recognition was justified as meeting the need to better utilize existing sources of protein in replacing meat with protein from less costly sources. Some commercial activity utilizing soy protein isolate as part of the brine had occurred in the United States in the ten years preceding formal recognition but the bulk of the commercial activity has occurred in Europe.

Starting in the mid-1960's, a large number of ham processors augmented the brine with a soy protein isolate marketed by Central Soya Company, Inc. under the make “PROMINE”. This soy protein isolate conforms to the foregoing definition, being prepared from selected, defatted soybean flakes obtained by the solvent extraction processing of high quality, sound, clean, dehulled soybeans. These flakes are treated in mildly alkaline aqueous medium to extract the soluble protein constituents, carbohydrates, mineral matter, and other soluble minor flake components from insoluble matter.

The protein-containing extract is then separated from residual flake material and subsequently acidified to about pH 4.5 with food-grade hydrochloric acid. This results in the precipitation of the major globulin fractions of the soybean protein as a finely-divided white curd. This curd is then separated, washed with water, and dispersed at about pH 7.0 with food-grade sodium hydroxide. The resulting protein dispersion is spray dried.

A typical soy isolate augmented brine employed over the years in Europe included 4% isolate, 10% salts including the chloride and nitrite, 3% phosphate and 3% sugar including monosodium glutamate with the remainder water. In some cases, higher or lower concentrations of isolate were employed. The concentration of the isolate was generally a matter determined by customer taste and it was found that there were distinct preferences in different countries. For example, Spanish ham processors desired a less pink ham than those in France. A variety of differences in taste, appearance, etc. could be found in the products in the other countries employing isolate during the past decade, viz., Holland, Poland, Norway, Denmark, Sweden, etc.

This isolate augmented brine has been pumped into hams both via the arterial-venous system and by stitch pumping. Stitch pumping has come to be preferred because it is faster and more economical, and is more reliable, not being subject to vein or artery rupture or blockage.

Generally the concentrations of isolate in the brine were maintained at a level of about 5%—this primarily being due to the difficulty in rapidly developing the isolate dispersion and thereafter handling the same incident to pumping. It will be appreciated that a ham processing plant is not normally characterized by the refinements and techniques of the analytical laboratory so that higher isolate concentrations which were feasible under more controlled conditions were normally avoided because of the essential ruggedness of the working conditions in ham processing plants.

It was felt desirable to be able to increase the concentration of isolate in the brine—for a number of reasons. Principally, this would permit increasing the effective weight of hams with proportionately less costly ingredients. However, to be acceptable, the water-isolate relationship should be such that after cooking, the isolate was present in the remaining water at a level comparable to the percentage of protein actually present in the ham, viz., 17-20%. So it was not just a matter of utilizing the water binding power of isolate—the isolate concentration had to be stepped up as more water was employed.

U.S. Pat. No. 3,989,851 (Hawley, et al., Nov. 2, 1976) relates to meats that are effectively pumped in excess of 140% of their green weights, yet maintain their original proteinaceous posture and nutritional value by a critically controlled preparation and injection of a protein medium. A salt tolerance protein isolate is hydrated in water and subsequently curing salts are admixed to the hydrated salt tolerant protein isolate. Upon curing, the liquid medium, which has been pumped into the meat, cooks to a uniformly distributed, meat-like gel, the extra pumped meat product maintains the same nutritional protein value and substantially identical textural properties of natural meat tissue, the protein substantially retains its hydrated form in the final product and there is substantially no protein separation.

U.S. Pat. No. 4,164,589 (Kadane, et al., Aug. 14, 1979) relates to a meat pumping process employing soy protein isolate and, more particularly, a non-gelable, soy protein isolate which is rapidly dispersible in water to provide a portion of the pumping medium, i.e., “brine”.

U.S. Pat. No. 4,381,316 (Brotsky, et al., Apr. 26, 1983) relates to protein fortified cured meat comprising cured intact skeletal meat muscle tissue having incorporated therein a whey protein composition having more than about 30% by weight whey protein on a dry solids basis and processes for preparation of the same.

U.S. Pat. No. 4,407,833 (Swartz, Oct. 4, 1983) relates to red meats such as beef, pork, veal, lamb or mutton in the non-comminuted form that are utilized extensively in the American diet as a protein source. However, the quantities per consumer have in recent years been lower and the cost of producing a pound of red meat has increased significantly, thus causing a general overall increase in the price of fresh, red meat. Attempts have been made to solve the problem of the availability and high cost of red meats by the introduction of solid protein extenders for use with comminuted meats such as beef. This type of system has not received large scale acceptance due to the flavor problems which naturally are attendant with the soy bean, i.e., the beany flavor.

Since the price of cured meat has increased significantly and since the quantities per consumer are less, an extension of the meat with a lower cost protein of high nutritional value is finding economic impetus. More commercial interest is being directed to the area of protein extended cured meat which product is termed a “combination meat product”, i.e., combination ham. However, such products will not become commercially feasible unless the fortification can be accomplished while providing a product of good color, texture, appearance and taste. Government clearance of the products have heretofore required that the protein content of the final extended meat product be about equal to or greater than the protein content of the original meat. This would require that the protein fortifier be added in a large enough quantity to provide the necessary protein while not significantly affecting the color, taste, appearance, and texture of the meat.

### SUMMARY OF THE INVENTION

In accordance with the present invention, there is provided a protein fortified meat characterized by good flavor, color, appearance and texture by incorporation into intact skeletal meat muscle tissue a brine of a protein fortifying composition, comprising,
(A), a vegetable protein material,
(B) a dairy whey protein material, and
(C) an aqueous solution of a curing material.

Also disclosed is a process for preparing a protein fortified meat, comprising intact skeletal meat muscle tissue as the sole meat source, having incorporated into the muscle tissue of said meat a brine of a protein fortifying composition, comprising;
combining
(A) a vegetable protein material and
(B) a diary whey protein material with
(C) an aqueous solution of a curing material to form the brine of the protein fortifying composition; and
injecting the brine of the protein fortifying composition into the meat.

Meats fortified in this manner are characterized by good color even after storage and no observable build-up of protein pockets. The protein composition, when mixed with curing materials and water to form a brine, can be injected into meats in amounts above 150% extension.

### DETAILED DESCRIPTION OF THE INVENTION

As used herein the term “% extension” or its cognates is intended to mean the amount of brine (proteins, curing salts and water) incorporated into the meat. When a 100 gram sample of meat is incorporated with 70 grams of brine, there is a 70% extension of the meat. When 125 grams brine is injected into the 100 gram meat sample, there is a 125% extension.

As used herein, the term “cured” is intended to include the application of brine or other curing compositions in liquid form to the interior and/or the exterior of the meat. The term “cured” is also intended to cover dry-cured products to the extent that the meat is injected with a protein composition comprising a vegetable protein material (A) and a dairy whey protein material (B), before or after curing.

As used herein, the term “cured meat” is intended to include the non-comminuted red meats such as beef, pork, veal, lamb or mutton, wild meats such as venison as well as intact poultry such as chicken, turkey, geese, capon, Cornish hens, squab, duck, guinea fowl and pheasants, which are cured by chemical means such as salt (NaCl) and/or sodium nitrite.

As used herein, the term “intact skeletal meat muscle tissue” is intended to mean that the meat is in a state recognizable as meat muscle tissue. Thus, the meat muscle tissue and muscle fiber bundles which makes up the meat are as in the natural animal. Intact is not intended to include comminuted meats where the muscle tissue has been so reduced in size as to destroy the integrity of the muscle fiber bundles. Intact meat is also intended to cover pieces of meat which have been reduced in size from that of the original source to a size wherein the reduction has not been such that the muscle fiber bundles have been destroyed and wherein the size is sufficiently large to allow incorporation of the protein fortifying composition. Generally, meat reduced to a particle size wherein the smallest of any dimension of the particle (length, width, depth, or diameter) is ½″ or above is usable in the invention.

As used herein the term “incorporating” is intended to mean inserting the composition of the vegetable protein material (A) and a dairy whey protein material (B) into the muscle tissue in the natural fiber bundle spaces.

The Vegetable Protein Material (A)

Preferred vegetable protein materials useful in the composition of the present invention comprise soy protein materials or corn protein materials. Preferred proteins may also include vegetable whey proteins (i.e., non-dairy whey protein) such as the whey protein fraction generated in the soy protein process.

Soybean protein materials which are useful with the present invention are soy flour, soy concentrate, and, most preferably, soy protein isolate. The soy flour, soy concentrate, and soy protein isolate are formed from a soybean starting material which may be soybeans or a soybean derivative. Preferably the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

The soy flour, soy concentrate and soy protein isolate are described below as containing a protein range based upon a “moisture free basis” (mfb).

Soy flour, as that term is used herein, refers to a comminuted form of defatted soybean material, preferably containing less than 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 49% to about 65% on a moisture free basis (mfb). Preferably the flour is very finely ground, most preferably so that less than about 1% of the flour is retained on a 300 mesh (U.S. Standard) screen.

Soy concentrate, as the term is used herein, refers to a soy protein material containing about 65% to about 72% of soy protein (mfb). Soy concentrate is preferably formed from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4.0 to about 5.0, and most preferably at a pH of about 4.4 to about 4.6. The isoelectric wash removes a large amount of water soluble carbohydrates and other water soluble components from the flakes, but removes little of the protein and fiber, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein and fiber remain insoluble while the carbohydrate soy sugars of sucrose, stachyose and raffinose are leached from the defatted flakes. The soy soluble sugars in the aqueous alcohol are separated from the insoluble protein and fiber. The insoluble protein and fiber in the aqueous alcohol phase are then dried.

Soy protein isolate, as the term is used herein, refers to a soy protein material containing at least about 90% or greater protein content, and preferably from about 92% or greater protein content (mfb). Soy protein isolate is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted soy protein material or soybean flakes are then placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the vegetable protein material is usually between about 20 to 1 and preferably a ratio of about 10 to 1. In an alternative embodiment, the vegetable protein is extracted from the milled, defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the vegetable protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the protein material is subjected to a pasteurization step. The pasteurization step kills microorganisms that may be present. Pasteurization is carried out at a temperature of at least 180° F. for at least 10 seconds, at a temperature of at least 190° F. for at least 30 seconds or at a temperature of at least 195° F. for at least 60 seconds. The protein material is then dried using conventional drying means to form a soy protein isolate. Soy protein isolates are commercially available from Solae® LLC, St. Louis, Mo., for example, as SUPRO® 500E, SURPO® EX 32, SUPRO® EX 33, SUPRO® 590, SUPRO® 595, SUPRO® 548, SUPRO® SYSTEMS M9, and SUPRO® SYSTEMS M112.

Preferably the soy protein material used in the present invention, is modified to enhance the characteristics of the soy protein material. The modifications are modifications which are known in the art to improve the utility or characteristics of a protein material and include, but are not limited to, denaturation and hydrolysis of the protein material.

The soy protein material may be denatured and hydrolyzed to lower the viscosity. Chemical denaturation and hydrolysis of protein materials is well known in the art and typically consists of treating an aqueous protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a protein material are: a pH of up to about 10, preferably up to about 9.7; a temperature of about 50° C. to about 80° C. and a time period of about 15 minutes to about 3 hours, where the denaturation and hydrolysis of the aqueous protein material occurs more rapidly at higher pH and temperature conditions.

Hydrolysis of the soy protein material may be effected by treating the protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the protein material, typically from about 0.1% to about 10% enzyme by weight of the protein material, and treating the enzyme and protein material at a temperature, typically from about 5° C. to about 75° C., and a pH, typically from about 3 to about 9, at which the enzyme is active for a period of time sufficient to hydrolyze the protein material. After sufficient hydrolysis has occurred the enzyme is deactivated by heating to a temperature above 75° C., and the protein material is precipitated by adjusting the pH of the solution to about the isoelectric point of the protein material. Enzymes having utility for hydrolysis in the present invention include, but are not limited to, bromelain and alcalase.

A starch material may also be used as an ingredient to be mixed with the soy protein material. Starch is a polymer of D-Glucose and is found as a storage carbohydrate in plants. The starch granules are completely insoluble in cold water but when heated the granules start to swell. The granules thus are useful to retain water after cooking. This helps to control cost since starch normally is a low cost item. The problem is that starch will not form a structure or interact with the proteins and as a result their contribution to texture is very limited. In other words, starch is added to hold water and control cost. The level of starch employed varies, but depending on the market and the quality of the starch, between 10% to 40% on a moisture free basis of starch is used in the soy protein material.

The starch material used is preferably a naturally occurring starch. Starch materials useful in the process of the present invention include corn starch, wheat starch, rice starch potato starch, or pea starch. Preferably the starch material used is a corn starch or a wheat starch, and most preferably is a commercially available dent corn starch or native wheat starch. A preferred dent corn starch is commercially available from A. E. Staley Mfg., Co. sold as Dent Corn Starch, Type IV, Pearl.

The Dairy Whey Protein Material (B)

The dairy whey protein material (B) used in the present invention can be derived from either acid whey or sweet whey as desired. Acid whey is the byproduct obtained from the acid coagulation of milk protein by the use of a lactic acid producing bacteria (e.g., lactobacillus) or by the addition of food grade acids such as lactic or hydrochloric acid, i.e., by direct acidification. In either case, acidification is allowed to proceed until a pH of approximately 4.6 is reached. At this pH, casein becomes insolubilized and coagulates as cheese curd. The cheese commonly produced by this method is called “cottage cheese”. The whey obtained as a by-product from this method is commonly called “acid” or “cottage cheese whey”.

The dairy whey protein material, as a dairy whey protein concentrate or dairy WPC, can also be derived from the production of cheddar cheese which is commonly produced by the rennet coagulation of protein. This cheese whey is commonly called “sweet” or “cheddar cheese whey”. Whey derived from other cheese manufacturing processes can also be used.

The dairy whey protein concentrate must be hydratable or dispersible to the extent of forming an injectable solution. As used herein, the term “hydratable” is intended to include injectable dispersions. Otherwise, the material cannot be incorporated (injected) into the meat. Processes which can be utilized to prepare dairy whey protein concentrates in a hydratable form include electrodialysis (Stribley, R. C., Food Processing, Volume 24, No. 1, p. 49, 1963), Reverse Osmosis, Marshall, P. G. et al., Fractionation and Concentration of Whey by Reverse Osmosis, Food Technology 22(a) 696, 1968, Gel Filtration (U.S. Pat. No. Re. 27,806), or Ultrafiltration, Horton, B. S. et al., Food Technology, Volume 26, p. 30, 1972. Chemical methods such as phosphate precipitation as described in Gordon U.S. Pat. No. 2,388,624 and Melachouris U.S. Pat. No. 4,043,990 can be used if the products obtained from those chemical precipitation methods are hydratable.

The dairy whey protein concentrate utilized in the present invention is derived from either the acid whey protein concentrate or the sweet whey protein concentrate. The % protein in the dairy whey protein concentrate is at least 50% and preferably at least 60% on a moisture free basis. The % protein in the dairy whey protein concentrate is not greater than 80% Representative dairy whey protein concentrates are Proliant™ 8600 and Proliant™ 8610, manufactured by Hilmar Cheese Co., Hilmar Calif.; Alacen 878 manufactured by Fonterra, Auckland, New Zealand; and Avonlac, manufactured by Glanbia Ingredients, Monroe, Wis. Whey protein concentrates containing 80% protein are preferred. The 80% whey protein concentrate has from 2% to 7% moisture, 5% to 8% lactose, 5% to 8% fat and 5% to 9% ash. The whey protein concentrate may be in a dry form to avoid the need for refrigeration, although a liquid whey protein concentrate may also be used if desired. As used herein, the term “whey protein concentrate” is also intended to include any of the products prepared by other methods which have a whey protein concentration of at least 50% on a dry solids basis and which composition is hydratable under the conditions of the meat treatment.

The Curing Material (C)

The curing material comprises curing salts and flavoring ingredients. The curing salts are sodium chloride, and sodium nitrite; the alkali metal phosphates of mono, di and trialkali metal orthophosphates such as monosodium phosphate and disodium phosphate, alkali metal tripolyphosphates such as sodium tripolyphosphate, alkali metal pyrophosphates such as tetrasodium pyrophosphate and sodium acid pyrophosphate, alkali metal polyphosphates such as sodium hexametaphosphate, and mixtures thereof and the like as well as sodium hydroxide/phosphate blends (i.e., four parts phosphate per part sodium hydroxide) and their potassium homologues; cure accelerators, i.e., ascorbic acid, erythorbic acid, their sodium and potassium salts, and mixtures as well as blends thereof with up to 50% citric acid or sodium citrate. The flavoring ingredients are sugar, (dextrose), brown sugar, spices, spice extracts, hydrolyzed vegetable protein, and artificial or liquid smoke; flavor enhancers, i.e., monosodium glutamate, hydrolyzed vegetable protein; proteolytic enzymes for softening beef tissue and carbonates and bicarbonates of alkali metals, such as sodium, in an amount sufficient to stabilize sodium erythorbate and sodium nitrite solution to pH 5.6 at pickle temperature of about 5° C. The amount and type of curing materials will depend on the type of meat cured and the cure normally used by that manufacturer.

The sodium chloride aids in the extraction of meat protein (the contractile proteins of meat are soluble in a 0.6 molar salt solution), and to a certain degree acts as an anti-microbial agent. The extraction of meat proteins is of the utmost importance since it helps with the retention of water, provides the characteristic texture and serves as a binder to hold the pieces of meat together. Sodium chloride also provides flavor. The level of use of salt is between 1.5% to 2.5% mfb of the protein fortified meat product.

Dextrose not only provides flavor, but also helps to mask the flavor of salt when salt is added at a high level of use. The level of use of dextrose is at least 0.5% mfb of the protein fortified meat product. However, since dextrose is a flavoring, its level can vary according to preference.

The function of phosphates are various, but the most important ones are as follows. They act as heavy metal chelators, thus being potent anti-oxidants; by nature of their pH, they help control the pH of the meat mixture and help to control water retention by moving the pH away from the isoelectric point of the meat proteins; they act as ATP (adenosine triphosphate) agents which is responsible for muscle relaxation in live animals but after death there being no oxygen, no more ATP is produced, thus causing a sustained contraction, which is nothing more than muscle proteins being locked together, rendering amino acids side chains unavailable to bind water; and act as an anti-microbial agent. Phosphates are employed at a level of from 0.25% to 0.5% mfb of the protein fortified meat product.

Sodium nitrite is the ingredient in the protein fortified meat products responsible for the development of the characteristic pink color by reacting with myoglobulin, the oxygen carrier protein in muscle. Sodium nitrite is also present as an anti microbial agent against the dangerous pathogens Clostridium botulinum, Clostridium difficile, and Helicobacter pylori. Its level of use is at a minimum of 155 parts per million, ppm mfb (based on level necessary for control of C. botulinum). However, is not unusual to use a higher level (200 ppm-250 ppm).

Sodium erythorbate, sodium ascorbate, erythorbic acid and ascorbic acid, are utilized as reductants and curing accelerators in manufacturing of cured meats. The ascorbates and erythorbates are essentially the same; they are optical isomers of each other and are indistinguishable in curing mixtures. It is fair to note that ascorbic acid has a biological function (vitamin C) which is not performed by erythorbic acid. The salts (sodium Erythorbate and sodium ascorbate) are usually chosen for use in cured meats, because the acid forms may deplete nitrite from the curing mixture too quickly, and reduce its overall effectiveness. The typical level of use is 550 ppm mfb of the protein fortified meat product, but a rule of thumb is that it is necessary to employ ascorbates and erythorbates at a level of at least 3 times the amount of nitrites, in order for the ascorbates and erythorbates to be effective.

Carrageenan is a hydrocolloid extracted from Chondrus crispus (a type of sea weed), and due to its chemical structure, has strong gelling properties. Carrageenan is used in whole muscle products to retain water after packaging (during storage). Carrageenan complements the effect of proteins and starches in the protein fortified meat products. The level of use is from 0.25% to 0.6% mfb of the finished protein fortified meat products.

Anti-microbial agents, as their name suggests, are ingredients used to control the development of spoiling microorganisms. In recent years one of the most popular one has been sodium lactate which is very effective. The level of use has to be at least 2% mfb of the finished protein fortified meat products, in order to be effective.

The brine of the protein fortifying composition for meat fortification comprises the protein material (A), a dairy whey protein material (B), and an aqueous solution of the curing material (C). The brine is prepared according to the following procedure. Water, just above the freezing point (about 2° C.) is placed in a vessel and added in order with stirring are the alkali phosphates and the alkali salts (NaCl, NaNO₂). Stirring is continued and the temperature is lowered to about −2° C. and added in order are the vegetable protein material (A), the dairy whey protein material (B), the flavorings, the hydrocolloids, the salts of alkali ascorbate, alkali erythorbate and starch. The ratio of the protein content of (A)+(B) to (C) is from 2.0 to 5.0:1 and preferably from 2.5 to 3.5:1 on a moisture free basis. The aqueous content is generally from 60% to 85% and preferably from 70% to 80%. The weight ratio of (A) to (B) on a moisture free basis is generally from 30-90 to 70-10, preferably from 50-85 to 50-15 and most preferably from 70-80 to 30-20. The protein fortified meat generally contains from 1.0% to 10.0% and preferably from 2% to 5% soy protein and generally from 0.25% to 5.0% and preferably from 0.5% to 2% dairy whey protein. Further, the brine has a viscosity of not more than 250 centipoise.

The meats which can be protein fortified in accordance with the invention include pork derived meats such as hams, pork shoulders, picnics, loins, butts, and bacon; beef derived meats such as round or brisket (peppered beef round, pastrami, tongue, corned beef, brisket or round); poultry; and, to a lesser extent, lamb, veal and wild animal such as deer. The meat can be sold in larger pieces such as a whole ham, or smaller pieces such as corned beef, in whole or sliced form, or in any form particular to that meat such as whole hams, boned hams, oval hams, pear-shaped hams, canned, boiled, smoked or dried. The solid meat can also be a formed product known as sectioned and formed. Sectioned and formed is intended to be limited to large intact meat products prepared from smaller, intact pieces and is not intended to cover comminuted meat. The meat can be boned if desired though this is not essential.

The poultry meat is preferably from chicken or turkey or mixtures thereof which can be fortified in accordance with the present invention in the form of whole poultry or poultry parts. Poultry parts include whole breast, fillets, sectioned and formed, rolled, and the like. The protein fortification can be applied to poultry destined for any normal cured poultry.

The protein fortification of the brine of (A), (B) and (C) is distributed through the meat by one of the two following systems. The first system is by injection of the brine of the protein fortifying composition. The second system is by adding the brine of the protein fortifying composition to a mixer along with the meat and forcing the brine of the protein fortifying composition into the meat by mechanical action. Both systems are widely used and offer advantages and disadvantages. The decision of the system will depend on equipment availability and on the market conditions capable of returning an investment.

Injection (stitch pumping) offers the possibility of utilizing bigger pieces of meat, which in turn will render a higher quality meat product. Injection will distribute the brine of the protein fortifier composition evenly throughout the meat, making the mix fortifying process easier to be effective.

The brine of the protein fortifying composition addition to the mixer requires the use of smaller pieces of meat, therefore the quality of the resulting product is not appreciated as much, since a stronger mixing is necessary to achieve an even distribution of the brine. It is very important to understand that both systems are heavily impacted by brine viscosity.

There is only one known limit for the amount of the brine of the protein fortification that can be pumped into the meat, and that is the viscosity of the brine of the protein fortifying composition. The brine of the protein fortifying composition can be pumped as high as 160% of green weight (160% extension). The preferable limits to the amount of protein added are the limits which enables the brine of the protein fortifying composition to be pumped. The viscosity of the brine of the protein fortifying composition is not more than 250 centipoise.

High brine protein fortifying composition viscosity will make it very difficult to inject and is hard on the equipment, requiring more maintenance of the equipment, as injection needles tend to clog and injection pumps work in a stress condition. A viscous brine protein fortifying composition is more difficult to distribute and tends to accumulate in between muscle fibers and shows in the finish product as gel pockets or stretch marks. A heavier mixing is required.

High brine protein fortifying composition viscosity when added directly to the mixer, will tend to coat the meat pieces preventing protein fortifying composition penetration and distribution through the meat, this in turn will prevent meat protein extraction, which is crucial for water holding and as a glue to bind meat pieces together after cooking. Products will be softer and will tend to break when sliced.

The meat products can then be processed by standard industry techniques including those necessary to meet governmental regulations. Pork must be held at a temperature not above 28° F. for 30 days to be certified free of trichinosis or cooked to an internal temperature of at least 140° F. Pork is usually smoked at above these temperatures for the final product. Beef such as corned beef is sold refrigerated and uncooked.

It is also considered within the scope of the invention to inject the brine of the protein fortifying composition into cured meat which is already cooked (smoked).

The product of the present invention is a protein-fortified cured meat characterized by good flavor, color, texture and taste. Equivalent results are obtained from cooked and uncooked meats as well as from boned or unboned meats.

The following examples are illustrative of the preparation of the protein fortifying composition of this invention. Unless otherwise indicated, all parts and percentages are by weight which follow.

### EXAMPLE 1

A curing salt solution is prepared by adding 97.65 kilograms water to a mixing vessel. The water is cooled to 2° F. and added in order are: 629 grams sodium tripolyphosphate, 4.69 kilograms sodium chloride, 57 grams sodium nitrite, 12.53 kilograms Supro® Systems M112, 3.13 kilograms Proliant™ 8610, 893 grams dextrose, 4.19 kilograms maltodextrin, 1.37 kilograms carrageenan 205 grams sodium erythorbate, and 3.42 kilograms potato starch. When hydration and solution are complete, a brine is formed having a % protein content of 8.51. The viscosity of the brine is not more than 250 centipoise.

### EXAMPLE 1A

Deboned hams are injected with the brine of Example 1 to give a protein fortified meat having a 130% extension.

### EXAMPLE 2

The procedure of Example 1 is repeated except that 15.66 kilograms of Supro® Systems M112 is used in place of the combination of Supro® Systems M112 and the Proliant™ 8610. The viscosity of the brine is in excess of 250 centipoise and thus is too viscous to pump through injection needles.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A protein fortified meat, comprising intact skeletal meat muscle tissue as the sole meat source, having incorporated into the muscle tissue of said meat a brine of a protein fortifying composition, comprising;
(A) a vegetable protein material,
(B) a dairy whey protein material and
(C) an aqueous solution of a curing material.

2. The protein fortified meat of claim 1 wherein the vegetable protein material (A) comprises a soy protein material or a corn protein material.

3. The protein fortified meat of claim 2 wherein the soy protein material contains at least 49% protein on a moisture free basis.

4. The protein fortified meat of claim 2 wherein the soy protein material comprises a soy protein flour, a soy protein concentrate or a soy protein isolate.

5. The protein fortified meat of claim 2 wherein the soy protein material comprises a soy protein concentrate.

6. The protein fortified meat of claim 2 wherein the soy protein material is a soy protein isolate.

7. The protein fortified meat of claim 1 wherein the dairy whey protein material (B) contains at least 50% protein on a moisture free basis.

8. The protein fortified meat of claim 1 wherein the dairy whey protein material is a dairy whey protein concentrate.

9. The protein fortified meat of claim 1 wherein the curing material (C) comprises curing salts and flavorings.

10. The protein fortified meat of claim 9 wherein the curing salts comprise sodium chloride, sodium nitrite, the sodium phosphates, sodium ascorbate, or sodium erythorbate.

11. The protein fortified meat of claim 9 wherein the flavorings comprise dextrose, brown sugar, spices, spice extracts, hydrolyzed vegetable protein, and artificial or liquid smoke; flavor enhancers, proteolytic enzymes, sodium carbonate and sodium bicarbonates.

12. The protein fortified meat of claim 2 wherein the vegetable protein material further comprises a starch.

13. The protein fortified meat of claim 12 wherein the starch comprises corn starch, wheat starch, rice starch potato starch, or pea starch.

14. The protein fortified meat of claim 12 wherein the starch is present in the vegetable protein material at from 10% to 40% on a moisture free basis.

15. The protein fortified meat of claim 1 wherein said meat muscle tissue is selected from the group consisting of beef, pork, poultry, veal and lamb.

16. The protein fortified meat of claim 1 wherein said meat muscle tissue is pork.

17. The protein fortified meat of claim 16 wherein said pork is selected from the group consisting of ham, bacon, picnics and butts.

18. The protein fortified meat of claim 16 wherein said pork is ham.

19. A process for preparing a protein fortified meat, comprising intact skeletal meat muscle tissue as the sole meat source, having incorporated into the muscle tissue of said meat a brine of a protein fortifying composition, comprising;
combining
(A) a vegetable protein material and
(B) a diary whey protein material with
(C) an aqueous solution of a curing material to form the brine of the protein fortifying composition; and
injecting the brine of the protein fortifying composition into the meat.

20. The process of claim 19 wherein the vegetable protein material (A) comprises a soy protein material or a corn protein material.

21. The process of claim 20 wherein the soy protein material contains at least 49% protein on a moisture free basis.

22. The process of claim 20 wherein the soy protein material comprises a soy flour, a soy concentrate or a soy protein isolate

23. The process of claim 20 wherein the soy protein material comprises a soy concentrate.

24. The process of claim 20 wherein the soy protein material is a soy protein isolate.

25. The process of claim 19 wherein the dairy whey protein material (B) contains at least 50% protein on a moisture free basis.

26. The process of claim 19 wherein the dairy whey protein material is a dairy whey protein concentrate.

27. The protein fortified meat of claim 19 wherein the curing material (C) comprises curing salts and flavorings.

28. The protein fortified meat of claim 19 wherein the curing salts comprise sodium chloride, sodium nitrite, the sodium phosphates, sodium ascorbate, or sodium erythorbate.

29. The protein fortified meat of claim 19 wherein the flavorings comprise dextrose, brown sugar, spices, spice extracts, hydrolyzed vegetable protein, and artificial or liquid smoke; flavor enhancers, proteolytic enzymes, sodium carbonate and sodium bicarbonates

30. The process of claim 19 wherein the vegetable protein material further comprises a starch.

31. The process of claim 30 wherein the starch comprises corn starch, wheat starch, rice starch potato starch, or pea starch.

32. The process of claim 30 wherein the starch is present in the vegetable protein material at from 10% to 40% on a moisture free basis.

33. The process of claim 19 wherein said meat muscle tissue is selected from the group consisting of beef, pork, veal and lamb.

34. The process of claim 19 wherein said meat muscle tissue is pork.

35. The process of claim 34 wherein said pork is selected from the group consisting of ham, bacon, picnics and butts.

36. The process of claim 34 wherein said pork is ham.

37. The process of claim 19 wherein the weight ratio of (A):(B) is from 30-90 to 70-10 on a moisture free basis.

38. The process of claim 19 wherein the weight ratio of (A):(B) is from 50-85 to 50-15 on a moisture free basis.

39. The process of claim 19 wherein the weight ratio of (A):(B) is from 70-80 to 30-20 on a moisture free basis.

40. The process of claim 19 wherein the weight ratio of the protein content of (A)+(B) to (C) is from 2.0 to 5.0:1 on a moisture free basis.

41. The process of claim 19 wherein the weight ratio of the protein content of (A)+(B) to (C) is from 2.5 to 3.5:1 on a moisture free basis.

42. The process of claim 19 wherein the brine has an aqueous content of from 60% to 85%.

43. The process of claim 19 wherein the protein fortified meat contains from 1.0% to 10.0% soy protein.

44. The process of claim 19 wherein the protein fortified meat contains from 2.0% to 5.0% soy protein

45. The process of claim 19 wherein the protein fortified meat contains from 0.25% to 5.0% dairy whey protein.

46. The process of claim 19 wherein the protein fortified meat contains from 0.5% to 2.0% dairy whey protein.

47. The process of claim 19 wherein the brine has a viscosity of not more than 250 centipoise.
